(19) United States
(12) Patent Application Publication
(10) Pub. No.: US 2016/0035126 A1
(43) Pub. Date: Feb. 4, 2016

(54) SYSTEM AND METHOD FOR 3D CONTENT CREATION

(71) Applicant: Sy Sen Tang, Hong Kong (HK)

(72) Inventor: Sy Sen Tang, Hong Kong (HK)

(21) Appl. No.: 14/793,759

(22) Filed: Jul. 8, 2015

Related U.S. Application Data
(60) Provisional application No. 62/030,579, filed on Jul. 29, 2014.

(51) Int. Cl. G06T 15/10; G06T 15/60

(52) U.S. Cl. CPC G06T 15/10; G06T 15/60

(57) ABSTRACT

A system for 3D content creation includes: a theme preparation module configured to prepare a 3D theme for a user; and a 3D rendering module configured to load the 3D theme and apply the 3D theme to 2D content provided by the user. The theme preparation module includes: means for preparing different rendering passes; means for packing the rendering passes to a 3D theme; and means for inputting the 3D theme into the system. The 3D rendering module includes: means for selecting a 3D theme; means for customizing the 3D theme with the 2D content; means for rendering the 2D content with the 3D theme into a plurality of frames in a 3D format; and means for combining the frames into a 3D video and outputting the 3D video. A method for 3D content creation is also provided.

### CROSS-REFERENCE TO RELATED APPLICATIONS

This application claims the benefit of U.S. provisional patent application No. 62/030,579 filed on Jul. 29, 2014; the contents of which is hereby incorporated by reference.

### FIELD OF THE PATENT APPLICATION

The present patent application generally relates to information technologies and more specifically to a system and a method for 3D content creation.

### BACKGROUND

3D television/display (3DTV) is a television/display that conveys depth perception to the viewer by employing techniques such as stereoscopic display or autostereoscopic display. Stereoscopic TV/display is also called glasses 3D TV/display, which requires special glasses and stereoscopic content to show 3D effects. Autostereoscopic TV/display is also called glasses-free 3D TV/display, which requires multi-views to show 3D effects. 3D content is an indispensable part of a 3D TV/display solution.

Currently 2D content is still the main stream in our society. Some techniques can help the existing 2D content show 3D effects in a 3D TV/display. In particular, the most common method is to convert 2D content into 3D content. With this approach, to achieve a high quality 2D to 3D conversion usually requires professionals to operate high-end software to produce it. And it usually takes a very long time. Further, the resulted 3D effects are very dependent of the original 2D content.

Another approach is making 2D content with 3D effects. A 3D computer generated object can be inserted into an original 2D content. With this approach, an operator needs to operate high-end 3D system to add the 3D computer graphics into the 2D scene. Same as the previous approach, it requires professionals to control the system and it is a time consuming process.

### SUMMARY

The present patent application is directed to a system and a method for 3D content creation. In one aspect, the system includes: a theme preparation module configured to prepare a 3D theme for a user; and a 3D rendering module configured to load the 3D theme and apply the 3D theme to 2D content provided by the user. The theme preparation module includes: means for preparing different rendering passes; means for packing the rendering passes to a 3D theme; and means for inputting the 3D theme into the system. The 3D rendering module includes: means for selecting a 3D theme; means for customizing the 3D theme with the 2D content; means for rendering the 2D content with the 3D theme into a plurality of frames in a 3D format; and means for combining the frames into a 3D video and outputting the 3D video.

The means for rendering the 2D content with the 3D theme may include means for loading data from the 3D theme and the 2D content, and matching proper frames of the 3D theme with the 2D content; and means for combining the rendering passes with the 2D content frame by frame.

The different rendering passes may be prepared by someone other than the user. The means for customizing the 3D theme with the 2D content may include means for allowing the user to import the 2D content and customize the 3D theme with the 2D content. The rendering passes may include Alpha of customized objects, color, global illumination, lighting and shadow, reflection and specular, UVW and ZDepth types of rendering passes. The rendering passes may be stored in a sequence image format.

The system may further include means for loading the rendering passes into the system; and means for processing each rendering pass one by one. The system may further include means for compositing a custom image to a color pass; means for multiplying the image with a lighting and shadow pass; means for multiplying the image with a global illumination pass; and means for adding the multiplied images.

The system may further include means for adding a reflection and specular pass; means for updating a preview window to allow the user to check progress of the rendering process; and means for outputting a final image to a storage disk. The system may further include means for encoding an image sequence output into a video file, and means for displaying the video file.

The system may further include means for setting the rendering output format, the rendering output format being a 2D format, 2D plus depth format, 8 views multiplexed format, 8 views format, stereo format, or 9 views format.

In another aspect, the method for 3D content creation includes: preparing a 3D theme for a user by a theme preparation module; and loading the 3D theme and applying the 3D theme to 2D content provided by the user by a 3D rendering module. The step of preparing the 3D theme includes: preparing different rendering passes; packing the rendering passes to a 3D theme; and inputting the 3D theme into the system. The step of loading the 3D theme and applying the 3D theme to the 2D content includes: selecting a 3D theme; customizing the 3D theme with the 2D content; rendering the 2D content with the 3D theme into a plurality of frames in a 3D format; and combining the frames into a 3D video and outputting the 3D video.

The step of rendering the 2D content with the 3D theme may include loading data from the 3D theme and the 2D content, and matching proper frames of the 3D theme with the 2D content; and combining the rendering passes with the 2D content frame by frame.

The rendering passes may include Alpha of customized objects, color, global illumination, lighting and shadow, reflection and specular, UVW and ZDepth types of rendering passes. The method may further include loading the rendering passes into the system, and processing each rendering pass one by one. The method may further include compositing a custom image to a color pass; multiplying the image with a lighting and shadow pass; multiplying the image with a global illumination pass; and adding the multiplied images. The method may further include adding a reflection and specular pass; updating a preview window to allow the user to check progress of the rendering process; and outputting a final image to a storage disk.

In yet another aspect, the present patent application provides a system for 3D content creation, the system including: a theme preparation module configured to prepare a 3D theme for a user; and a 3D rendering module configured to load the 3D theme and apply the 3D theme to 2D content provided by the user. The theme preparation module includes: means for preparing different rendering passes, the different rendering passes being prepared by someone other than the user; means for packing the rendering passes to a 3D theme; and means for inputting the 3D theme into the system. The 3D rendering module includes: means for selecting a 3D theme; means for customizing the 3D theme with the 2D content; means for rendering the 2D content with the 3D theme into a plurality of frames in a 3D format; and means for combining the frames into a 3D video and outputting the 3D video. The means for rendering the 2D content with the 3D theme into a plurality of frames in a 3D format includes: means for loading data from the 3D theme and the 2D content, and matching proper frames of the 3D theme with the 2D content; and means for combining the rendering passes with the 2D content frame by frame.

The system may further include means for loading the rendering passes into the system; means for processing each rendering pass one by one; means for compositing a custom image to a color pass; means for multiplying the image with a lighting and shadow pass; means for multiplying the image with a global illumination pass; and means for adding the multiplied images.

The system may further include means for adding a reflection and specular pass; means for updating a preview window to allow the user to check progress of the rendering process; and means for outputting a final image to a storage disk.

### BRIEF DESCRIPTIONS OF THE DRAWINGS

FIG. 1 is a block diagram illustrating a system for 3D content creation in accordance with an embodiment of the present patent application.

FIG. 2 is a flow chart illustrating an operation of the theme preparation module in the system for 3D content creation depicted in FIG. 1.

FIG. 3 is a flow chart illustrating an operation of the 3D rendering module in the system for 3D content creation depicted in FIG. 1.

FIG. 4 is a flow chart illustrating a step of rendering a section executed by the system for 3D content creation depicted in FIG. 1.

FIG. 5 shows a detailed workflow of a step of rendering preparation.

FIG. 6 shows a detailed workflow of a step of rendering processing.

FIG. 7 shows an example of a graphic user interface workflow of the system depicted in FIG. 1.

FIG. 8 shows examples of output formats of the system depicted in FIG. 1.

FIG. 9 shows a set of examples for rendering passes.

FIG. 10 shows a rendering process of one frame.

### DETAILED DESCRIPTION

Reference will now be made in detail to a preferred embodiment of the system and the method for 3D content creation disclosed in the present patent application, examples of which are also provided in the following description. Exemplary embodiments of the system and the method disclosed in the present patent application are described in detail, although it will be apparent to those skilled in the relevant art that some features that are not particularly important to an understanding of the system and the method may not be shown for the sake of clarity.

Furthermore, it should be understood that the system and the method disclosed in the present patent application is not limited to the precise embodiments described below and that various changes and modifications thereof may be effected by one skilled in the art without departing from the spirit or scope of the protection. For example, elements and/or features of different illustrative embodiments may be combined with each other and/or substituted for each other within the scope of this disclosure.

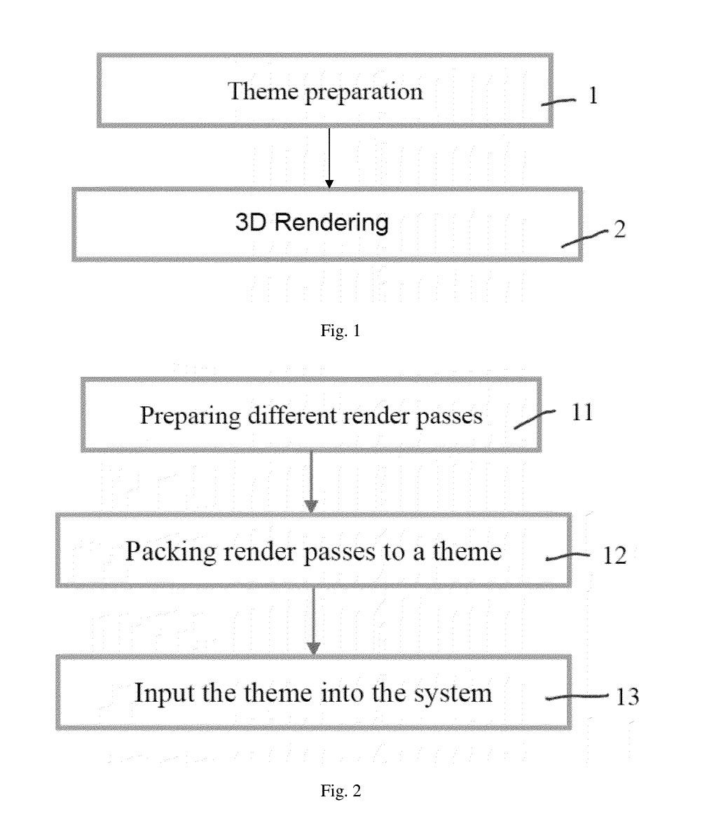

FIG. 1 is a block diagram illustrating a system for 3D content creation in accordance with an embodiment of the present patent application. Referring to FIG. 1, the system for 3D content creation includes a theme preparation module 1, and a 3D rendering module 2. In particular, the theme preparation module is configured to prepare a 3D theme for an end-user. A professional 3D designer or creator can, through this module, create the 3D theme for the end-user. The 3D rendering module 2 is configured to load the 3D theme and apply the 3D theme, which is prepared by the theme preparation module 1, to 2D content provided by the end-user. The end-user can use this module to customize their 2D content and render it to 3D content.

FIG. 2 is a flow chart illustrating an operation of the theme preparation module in the system for 3D content creation depicted in FIG. 1. Referring to FIG. 2, the theme preparation module 1 is configured to carry out the following steps: preparing different rendering passes (step 11), packing the rendering passes to a 3D theme (step 12), and inputting the 3D theme into the system (step 13). In particular, in preparing different rendering passes (the step 11), the theme preparation module 1 is configured to gather necessary rendering passes for the 3D theme. In this part, a professional can use different high-end software to generate the necessary rendering passes. In packing the rendering passes (the step 12), the theme preparation module 1 is configured to pack all prepared rendering passes and form a 3D theme. In inputting the theme into the system (the step 13), the theme preparation module 1 is configured to import the theme that is ready into the system for 3D content creation, and then an end-user can customize his 2D content with the selected 3D theme.

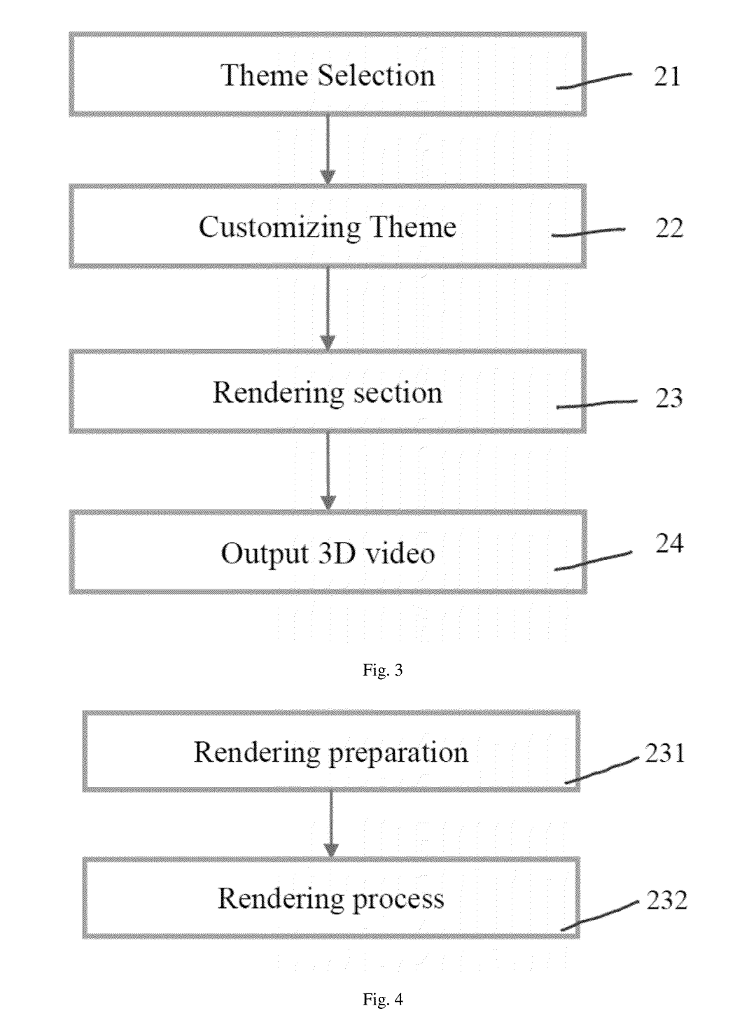

FIG. 3 is a flow chart illustrating an operation of the 3D rendering module in the system for 3D content creation depicted in FIG. 1. Referring to FIG. 3, the 3D rendering module 2 is configured to carry out the following steps: selecting a 3D theme (step 21), customizing the 3D theme (step 22), rendering a section (step 23), and outputting 3D video (step 24). In particular, in the step 21, the 3D rendering module 2 is configure to allow an end-user to select a preferred 3D theme. In the step 22, the 3D rendering module 2 is configured to allow the end-user to import the 2D content and customize the 3D theme with the 2D content. In the step 23, the 3D rendering module 2 is configured to render the 2D content with the 3D theme to a plurality of frames in a selected 3D output format. In the step 24, the 3D rendering module 2 is configured to combine all 3D output frames into a 3D video and output the 3D video.

FIG. 4 is a flow chart illustrating the step of rendering a section executed by the system for 3D content creation depicted in FIG. 1. Referring to FIG. 4, the step of rendering a section (the step 23) includes: rendering preparation (step 231) and rendering processing (step 232). In particular, in the step 231, the 3D rendering module is configured to load data from the 3D theme and the 2D source image/video, and match proper frames of the 3D theme with the input 2D source. The end-user can customize the 2D content with the 3D theme. It also allows the end-user to set up the output format. When all settings are done, the preparation is complete. The step 232 includes detailed processes of 3D rendering, such as combining the rendering passes with the 2D source content frame by frame.

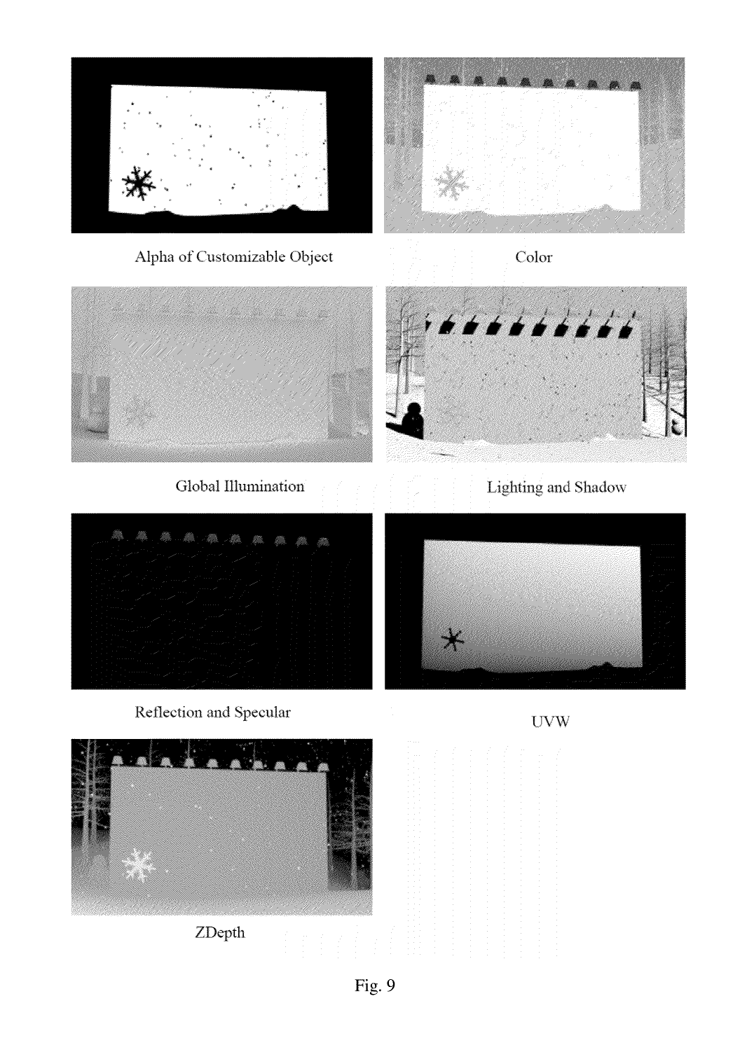

The above introduces the formation of the system for 3D content creation of this embodiment. Below is a description of the working concept of the system in combination with specific examples. As aforementioned, there are two main modules in this system for 3D content creation. The theme preparation module 1 is configured to set up the 3D theme for the 3D rendering module 2. The theme preparation module 1 is opened to all professional 3D designers. In preparing different rendering passes (the step 11), the 3D theme is created by a set of rendering passes. FIG. 9 shows a set of examples of rendering passes. Referring to FIG. 9, the rendering passes can be divided into Alpha of customized objects, color, global illumination, lighting and shadow, reflection and specular, UVW and ZDepth types of rendering passes. The rendering passes can be stored in a sequence image format. A 3D designer can produce the rendering passes by different high-end software. It is free for them to create the 3D themes by their creative ideas. In the 3D theme, they can design the position for the 2D content. After outputting all these rendering passes, the next step is to pack all these rendering passes to form a 3D theme (the step 12). In the step 12, the theme preparation module 1 is configured to store the rendering passes into a 3D theme format. When the 3D theme is ready, it can be loaded to the system for 3D content creation (the step 13).

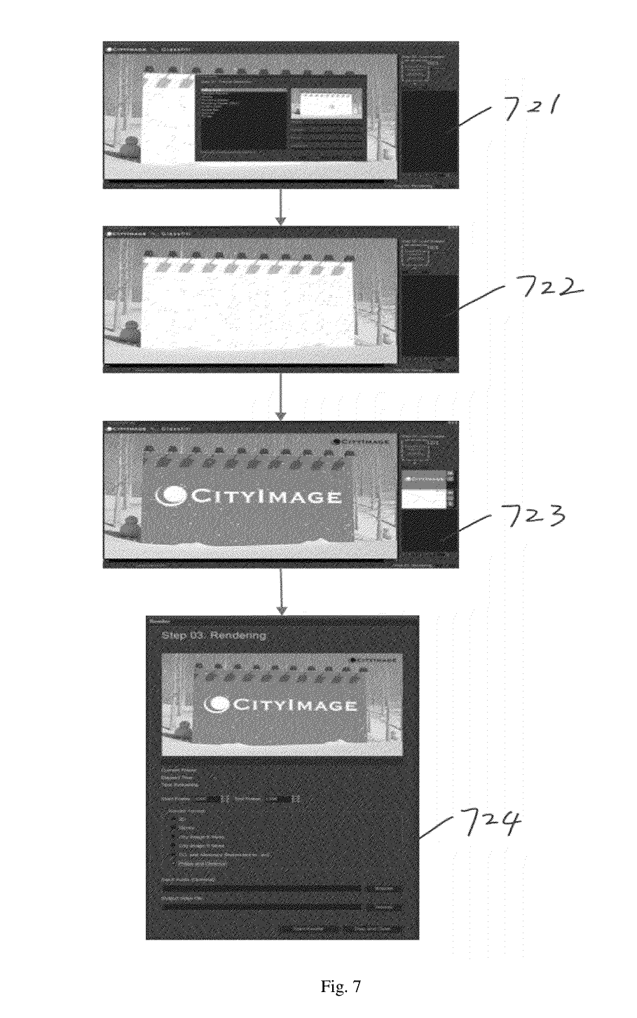

The system for 3D content creation accepts any 2D content (e.g. 2D still image, 2D sequence image, or 2D video) as an input source. And it can output content for glasses and glasses free 3D TVs/displays. The system allows different 3D themes to be stored in it. These 3D themes are pre-created in the theme preparation module 1. The end-user will mainly use the 3D rendering module 2 to create the 3D video. FIG. 7 shows an example of a graphic user interface workflow of the system. Referring to FIG. 7, an end-user firstly selects the theme (the step 21, shown as 721 in FIG. 7), then the user can customize the 2D content with the theme (the step 22, shown as 722 in FIG. 7), then the theme will be rendered (the step 23, shown as 723 in FIG. 7), and finally the system will output the 3D video result (the step 24, shown as 724 in FIG. 7).

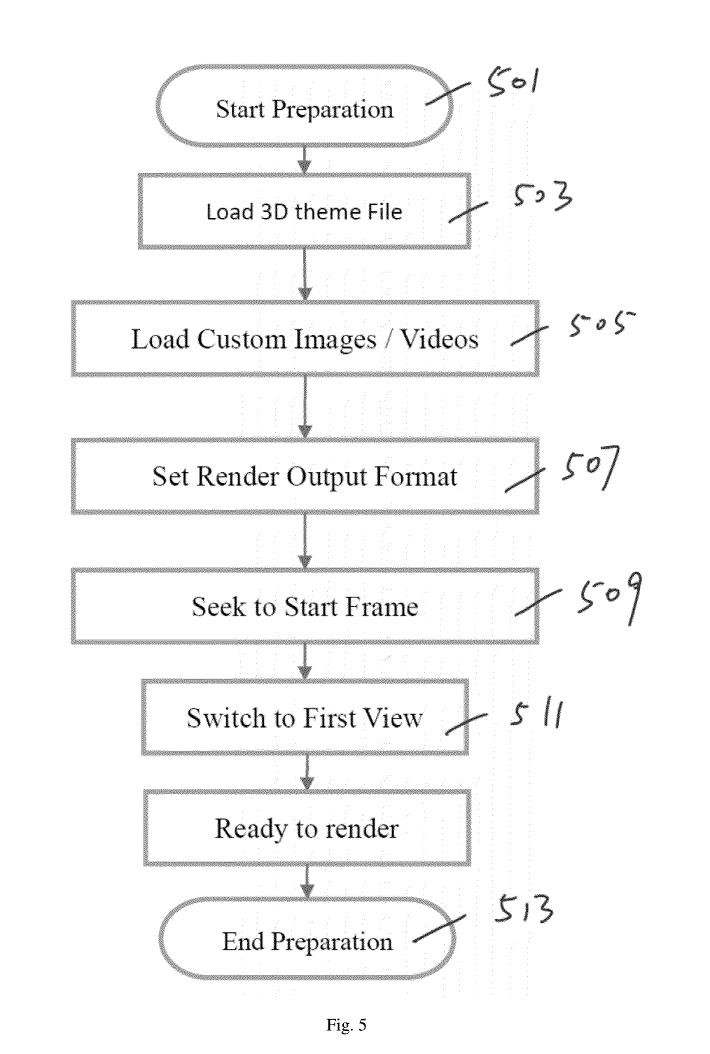

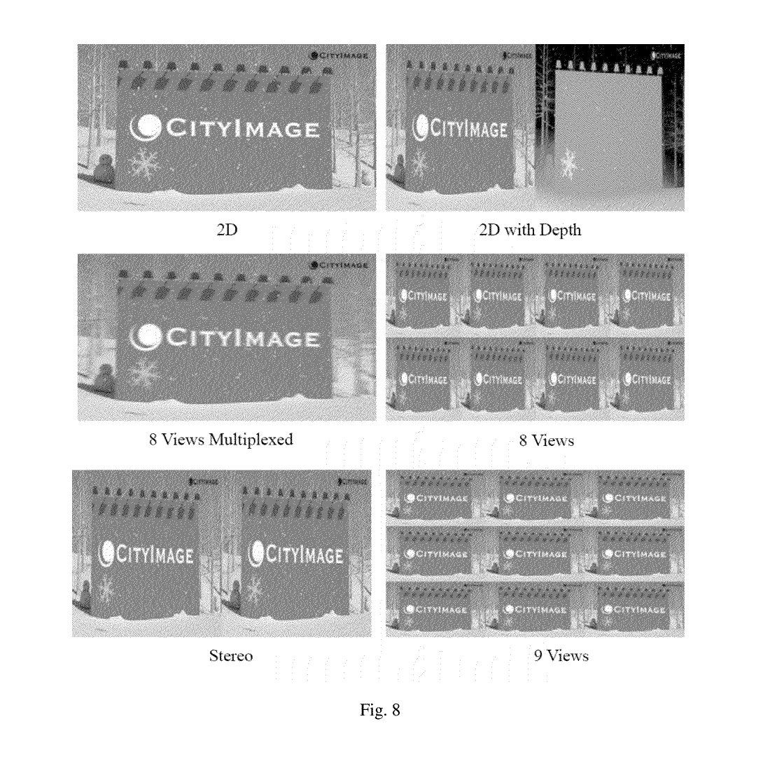

In this embodiment, the step 23 of rendering sections further includes rendering preparation (the step 231) and rendering processing (the step 232). The step 231 is for preparing the rendering materials. FIG. 5 shows a detailed workflow of the step 231. Referring to FIG. 5, when starting the preparation process (step 501), the 3D content creation system will load the 3D theme files into the system (step 503). Then it will load the custom image or video into the system (505). After that, it needs to set the rendering output format (step 507). FIG. 8 shows examples of the output formats. The output formats can be 2D format, 2D plus depth format, 8 views multiplexed format, 8 views format, stereo format, 9 views format or any other multi-views formats. After that, the system will seek for start frame of the sequence image (step 509). Then the preview window will switch to the first frame (step 511) and the preparation process is complete (step 513).

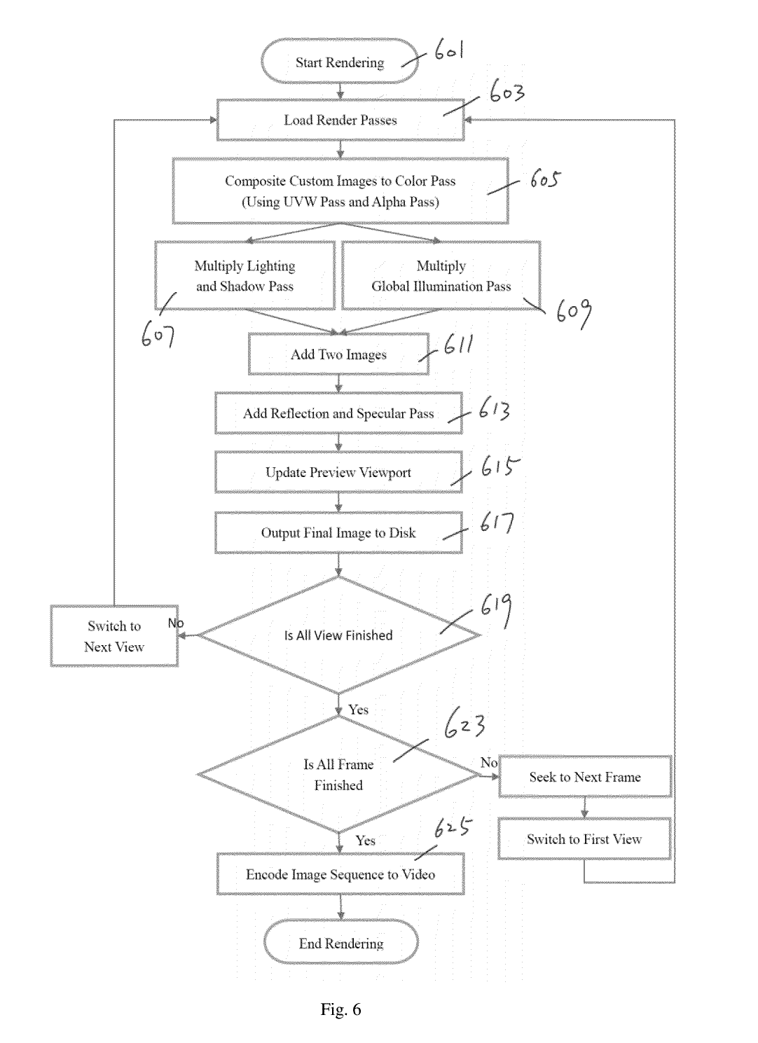

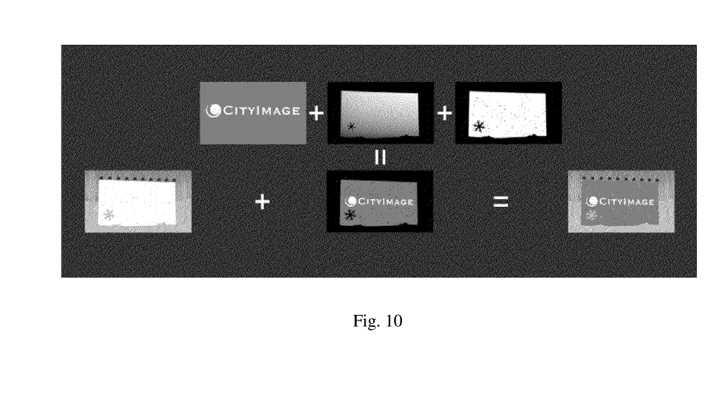

In this embodiment, in the step 232 of rendering processing, the render materials are processed and the 3D video file is outputted. FIG. 10 shows the rendering process of one frame executed by the system. FIG. 6 shows a detailed workflow of the step 232. Referring to FIG. 6 and FIG. 10, when the rendering is started (step 601), the system loads the rendering passes into the system (step 603), then it processes each rendering pass one by one.

Firstly the system composites a custom image to a color pass (step 605). The UVW pass guides system places a custom image in a proper position and an alpha pass indicates the transparent part of the theme. Then the image is multiplied with a lighting and shadow pass (step 607). At the same time, the image is also multiplied with the global illumination pass (step 609). After the multiplication the images are add together (step 611). After that, reflection and specular pass are added (step 613). The system then updates the preview window to allow the user to check the progress of the rendering process (step 615). Then the system outputs a resulted final image to a storage disk (step 617). The system supports multi-views rendering, and processes all views of a frame before it process the next frame. After all views are rendered (step 619), the system processes the next frame (step 623). When all sequence images are processed, the system encodes the image sequence output into a video file (step 625). This video file can display 3D in a proper display device.

The system and the method for 3D content creation provided by the above-mentioned embodiments significantly simplify the process of 3D content creation and guarantee the 3D effect quality of the content. The system is a platform to allow 3D creative talents to generate 3D themes for end-users. On the other hand, an end-user can follow three simple steps to generate content with high quality 3D effects. The system takes any 2D content as its input source. It can output great 3D effects and output in any 3D formats. The output format can support different 3D TVs/displays (glasses or glasses-free). The system and the method solve a major problem of 3D content creation.

While the present patent application has been shown and described with particular references to a number of embodiments thereof, it should be noted that various other changes or modifications may be made without departing from the scope of the present invention.

What is claimed is:

1. A system for 3D content creation, the system comprising:
a theme preparation module configured to prepare a 3D theme for a user; and
a 3D rendering module configured to load the 3D theme and apply the 3D theme to 2D content provided by the user; wherein:
the theme preparation module comprises:
means for preparing different rendering passes;
means for packing the rendering passes to a 3D theme; and
means for inputting the 3D theme into the system; and
the 3D rendering module comprises:
means for selecting a 3D theme;
means for customizing the 3D theme with the 2D content;
means for rendering the 2D content with the 3D theme into a plurality of frames in a 3D format; and
means for combining the frames into a 3D video and outputting the 3D video.

2. The system of claim 1, wherein the means for rendering the 2D content with the 3D theme comprises means for loading data from the 3D theme and the 2D content, and matching proper frames of the 3D theme with the 2D content; and means for combining the rendering passes with the 2D content frame by frame.

3. The system of claim 1, wherein the different rendering passes are prepared by someone other than the user.

4. The system of claim 1, wherein the means for customizing the 3D theme with the 2D content comprises means for allowing the user to import the 2D content and customize the 3D theme with the 2D content.

5. The system of claim 1, wherein the rendering passes comprise Alpha of customized objects, color, global illumination, lighting and shadow, reflection and specular, UVW and ZDepth types of rendering passes.

6. The system of claim 1, wherein the rendering passes are stored in a sequence image format.

7. The system of claim 2 further comprising means for loading the rendering passes into the system; and means for processing each rendering pass one by one.

8. The system of claim 7 further comprising means for compositing a custom image to a color pass; means for multiplying the image with a lighting and shadow pass; means for multiplying the image with a global illumination pass; and means for adding the multiplied images.

9. The system of claim 8 further comprising means for adding a reflection and specular pass;
means for updating a preview window to allow the user to check progress of the rendering process; and means for outputting a final image to a storage disk.

10. The system of claim 9 further comprising means for encoding an image sequence output into a video file, and means for displaying the video file.

11. The system of claim 2 further comprising means for setting the rendering output format, the rendering output format being a 2D format, 2D plus depth format, 8 views multiplexed format, 8 views format, stereo format, or 9 views format.

12. A method for 3D content creation, the method comprising:
preparing a 3D theme for a user by a theme preparation module; and
loading the 3D theme and applying the 3D theme to 2D content provided by the user by a 3D rendering module; wherein:
the step of preparing the 3D theme comprises:
preparing different rendering passes;
packing the rendering passes to a 3D theme; and
inputting the 3D theme into the system; and
the step of loading the 3D theme and applying the 3D theme to the 2D content comprises:
selecting a 3D theme;
customizing the 3D theme with the 2D content;
rendering the 2D content with the 3D theme into a plurality of frames in a 3D format; and
combining the frames into a 3D video and outputting the 3D video.

13. The method of claim 12, wherein the step of rendering the 2D content with the 3D theme comprises loading data from the 3D theme and the 2D content, and matching proper frames of the 3D theme with the 2D content; and combining the rendering passes with the 2D content frame by frame.

14. The method of claim 12, wherein the rendering passes comprise Alpha of customized objects, color, global illumination, lighting and shadow, reflection and specular, UVW and ZDepth types of rendering passes.

15. The method of claim 13 further comprising loading the rendering passes into the system, and processing each rendering pass one by one.

16. The method of claim 15 further comprising compositing a custom image to a color pass;
multiplying the image with a lighting and shadow pass; multiplying the image with a global illumination pass; and adding the multiplied images.

17. The method of claim 16 further comprising adding a reflection and specular pass;
updating a preview window to allow the user to check progress of the rendering process; and
outputting a final image to a storage disk.

18. A system for 3D content creation, the system comprising:
a theme preparation module configured to prepare a 3D theme for a user; and
a 3D rendering module configured to load the 3D theme and apply the 3D theme to 2D content provided by the user; wherein:
the theme preparation module comprises:
means for preparing different rendering passes, the different rendering passes being prepared by someone other than the user;
means for packing the rendering passes to a 3D theme; and
means for inputting the 3D theme into the system; and
the 3D rendering module comprises:
means for selecting a 3D theme;
means for customizing the 3D theme with the 2D content;
means for rendering the 2D content with the 3D theme into a plurality of frames in a 3D format, the means comprising:
means for loading data from the 3D theme and the 2D content, and matching proper frames of the 3D theme with the 2D content; and
means for combining the rendering passes with the 2D content frame by frame; and
means for combining the frames into a 3D video and outputting the 3D video.

19. The system of claim 18 further comprising means for loading the rendering passes into the system; means for processing each rendering pass one by one; means for compositing a custom image to a color pass; means for multiplying the image with a lighting and shadow pass; means for multiplying the image with a global illumination pass; and means for adding the multiplied images.

20. The system of claim 19 further comprising means for adding a reflection and specular pass; means for updating a preview window to allow the user to check progress of the rendering process; and means for outputting a final image to a storage disk.
